(19) United States
(12) Patent Application Publication
(10) Pub. No.: US 2020/0406287 A1
(43) Pub. Date: Dec. 31, 2020

(54) SYSTEM AND METHOD FOR TREATING A SURFACE OF AT LEAST ONE LARGE-FORMAT COMPONENT

(71) Applicant: Schaeffler Technologies AG & Co. KG, Herzogenaurach (DE)

(72) Inventors: Astrid Heckl, Nürnberg (DE); Christian Jakob, Wasserlosen (DE); Nikolay Podgaynyy, Adelsdorf (DE); Bertram Haag, Uehlfeld (DE); Yashar Musayev, Nürnberg (DE)

(73) Assignee: Schaeffler Technologies AG & Co. KG, Herzogenaurach (DE)

(21) Appl. No.: 16/978,840

(22) PCT Filed: Feb. 18, 2019
(86) PCT No.: PCT/DE2019/100149

§ 371 Date: Sep. 8, 2020

(30) Foreign Application Priority Data
Mar. 15, 2018 (DE) 10 2018 105 966.3

(51) Int. Cl. B05C 3/00; C23C 22/77

(52) U.S. Cl. CPC B05C 3/005; B05D 1/18; C23C 22/77

(57) ABSTRACT

A heatable treatment container for receiving a treatment bath for treating a surface of at least one large-format component having a diameter or dimensions in the range of 0.5 m to 12 m includes a container base with a container bottom, a container wall adjoining the container base, a removable lid, and a central heating column. The central heating column extends from the container bottom towards the removable lid or from the removable lid towards the container bottom. In an example embodiment, the central heating column extends from the container bottom over at least 50% of a height of the container wall towards the removable lid. In another example embodiment, the central heating column extends from the removable lid over at least 50% of a height of the container wall towards the container bottom.

### CROSS-REFERENCE TO RELATED APPLICATIONS

This application is the United States National Phase of PCT Appln. No. PCT/DE2019/100149 filed Feb. 18, 2019, which claims priority to German Application No. DE102018105966.3 filed Mar. 15, 2018, the entire disclosures of which are incorporated by reference herein.

### TECHNICAL FIELD

The disclosure relates to a system for treating a surface of at least one large-format component with a diameter or dimensions in the range of 0.5 m to 12 m. The disclosure further relates to a process for treating a surface of at least one large-format component with a diameter or dimensions in the range of 0.5 m to 12 m.

### BACKGROUND

Surface treatment methods are often used in the manufacture of components. Surface treatments are used, in particular, for corrosion protection and to increase the service life of components. Depending on the material used, various surface treatments are applied, such as galvanic, wet chemical or vapor deposition coatings. Often the chemicals used are hazardous to the environment, which is why various surface treatment methods are developed and carried out in reactors.

DE 10 2007 061 193 A1 discloses such a method for the surface treatment of a component subjected to rolling stress in the form of blackening.

DE 10 2015 222 902 A1 discloses a method for the surface treatment of a component using an apparatus consisting of a reactor or a treatment container equipped with the component. During the surface treatment of the component, the reactor is successively filled with different media.

DE 10 2017 112 736 A1 concerns a system concept with at least two treatment containers in order to extend the lifetime of the treatment media used.

GB 2280123 A describes a container for cleaning and phosphating iron workpieces. Rotating impellers and a heating element mounted on the container wall are provided for the circulation of a liquid in the container.

During the treatment, e.g., blackening or phosphating, of large-format components in treatment containers with the formation of a conversion layer, it has been shown that the use of conventional treatment systems leads to uneven treatment results when considering the surface of such a component. These different treatment results were reflected in different thicknesses of the conversion layer produced on the component surface.

It has been shown that these differences are due to the fact that large-format components with a diameter or dimensions in the range of 0.5 m to 12 m when placed in a preheated treatment bath cool down considerably. Due to the volume of the component and the treatment bath, the time required to reheat the treatment bath to the original temperature is longer than for the surface treatment of small-format components with a diameter or dimensions in the range of less than 0.5 m. The different temperatures of the treatment bath in the area of the component surfaces lead to a faster conversion of the component surface in areas with higher temperatures than in areas with lower temperatures. This is how the differences in the thickness of the conversion layer of a component arise, which can no longer be fully compensated for even by extending the treatment time.

Such large-format components, e.g., in the form of bearing components such as bearing rings or rolling elements, are required, for example, for use in wind turbines.

### SUMMARY

The disclosure provides a system and a method for treating a surface of at least one large-format component with a diameter or dimensions in the range of 0.5 m to 12 m, with which a surface treatment can be carried out as uniformly as possible.

The disclosed system for treating a surface of at least one large-format component with a diameter or dimensions in the range of 0.5 m to 12 m includes at least one heatable treatment container for accommodating a treatment bath and at least one component in the treatment bath. The treatment container includes a container base, a container wall adjacent to the container base, and at least one removable lid. The heatable treatment container has, as seen in a top view, at least one heating column in the center, which extends from the container base towards the lid and/or from the lid towards the container base.

It has been shown that conventional systems, in which the treatment containers are only equipped with heating elements in the area of the container wall, are not able to heat such large components evenly over the treatment bath in a short time. This effect is particularly noticeable when treating large bearing rings. In the area in the middle of the treatment bath and thus in the area of a bearing ring interior diameter, heating is slower than in the area of the container wall and bearing ring exterior diameter. This leads to conversion layers of different thickness on the interior and exterior diameter of the bearing ring, which is undesirable. The lid should largely prevent evaporation of the treatment bath from the treatment container and heat loss.

If at least one heating column is now provided in the center of the heatable treatment container to accelerate the heating process of the treatment bath after the at least one large-format component has been introduced into the treatment bath starting from the center of the treatment bath, the heating of the entire component can be accelerated and the treatment of the component can be made more uniform. Uniformly thick conversion layers are produced during surface treatment, for example by blackening or phosphating.

It has proved to be effective if the heating of the treatment container is designed symmetrically to and at a distance from a component in such a way that a uniform distribution of heat in the treatment bath takes place and this can be maintained or at least restored within 5 minutes, e.g., within 3 minutes, after a—possibly preheated—component has been placed in the treatment bath. The heat distribution is considered to be uniform if temperature differences of ±0.5° C. or less occur over the volume of the treatment bath.

The heating column can be designed as a solid cylinder or as a hollow cylinder. If the heating column is a hollow cylinder, the treatment container may have an opening in the middle of the container bottom, with the heating column forming a seal between the treatment bath and the outside the treatment container. Alternatively, a further container wall can be placed on the opening in the container bottom and the hollow heating column can be placed around this further container wall.

The at least one heating column may have a surface profile in contact with the treatment bath that follows the contour of an opening in a large-format component into which the heating column protrudes. If the component has a conical or barrel-shaped contour, e.g., in the area of an opening or passage, the heating column may be designed in such a way that it follows the conical or barrel-shaped interior contour at a distance. In this way, the distance between the component and the at least one heating column is evened out.

The treatment container may be closed after the introduction of at least one component until the end of a treatment period. For this purpose, the at least one lid is provided for the respective treatment container. The lid enables a rapid temperature equalization between the treatment bath in the treatment container and the at least one component. A separately inserted placement device for the reception of the at least one component may be included. In addition, evaporation of the treatment bath from the respective treatment container is prevented and heat loss is minimized, so that the heating of the treatment container can be minimized. Alternatively, a hood or similar can be provided to reduce heat and exhaust steam losses.

In order to reduce the heating costs for operating the treatment container, it is still possible to pressurize it, such that the treatment container and the lid closing it are operated under increased pressure similar to a pressure cooker.

A treatment container may contain collecting devices suitable for keeping the at least one component in the treatment medium during the intended treatment period. A holding device can be, for example, a shelf which is permanently installed on the respective treatment container or is only secondarily inserted or fixed in or on the treatment container, such as a separate storage rack or similar. In addition, such tubs or storage racks can hold several components simultaneously, so that several components can be treated simultaneously in one treatment container. In addition, a crane can be used to provide a pick-up device which transfers the at least one component, including a storage rack if necessary, for treatment into the respective treatment container and holds it in the respective treatment container for the intended treatment period.

To even out the formation of the conversion layer on the surface of the component, the component can be moved in the treatment medium. For bearing rings, rotation around the ring axis at a rotational speed in the range of 0 to 3 m/s has proven to be the most effective.

The at least one heating column may extend from the bottom of the container over at least 50% of a height H of the container wall towards the at least one lid. Alternatively or in combination, the at least one heating column extends from the at least one lid over at least 50% of a height H of the container wall towards the container bottom. If only one heating column is provided, it should extend over at least 80% of the height of the container wall. It is also possible to install two heating columns of different lengths at the same time, starting from the bottom of the container and from the lid and directed towards each other.

With regard to uniform radial heat dissipation, it has proven to be best if the at least one heating column has a round circumference in the top view. The at least one heating column is set up in such a way that it transfers heat radially to the treatment bath. In an example embodiment, the at least one heating column is electrically heated.

The treatment container may have at least one heating element, which is arranged in the area of the container wall and is designed to emit heat to the treatment bath towards the at least one heating column. The at least one heating element can be annular. In an example embodiment, such an annular heating element extends over at least 50%, e.g., at least 80%, of the height H of the container wall.

Alternatively, the at least one heating element can be rod-shaped or plate-shaped. It is also possible to arrange heating elements in the form of one or more pipe coils in the area of the container wall. In an example embodiment, at least four heating elements are arranged at equal distances from each other on the container wall, surrounding the at least one heating column. However, more than four heating elements can be provided to further improve heat distribution and consistency. Rod-shaped heating elements may be arranged upright on the container wall. The at least one heating element may extend over at least 50%, e.g., over at least 80%, of the height H of the container wall.

In an example embodiment, the at least one heating element may have a surface profile in contact with the treatment bath that follows an exterior contour of a large-format component. If the component has, for example, a conical or barrel-shaped exterior contour, the heating element may be designed in such a way that it follows the conical or barrel-shaped exterior contour at a distance. This evens out the distance between the component and the at least one heating element.

A hot thermal oil may flow through and heat the at least one heating element.

In an example embodiment, several heating elements are arranged in the treatment container in such a way that each is at an equal distance from the at least one heating column.

Care should be taken to ensure that the heating elements in the treatment container are arranged as symmetrically as possible, with the at least one heating column being arranged centrally in the middle of the treatment container (in the top view) and one or more heating elements in the area of the wall of the treatment container—e.g., at the same distance from one or more heating columns. The formation of as equal distances as possible between the surfaces of the component and the at least one heating column on the one hand and the heating elements on the other hand helps to achieve a uniform heat profile within the treatment container and thus a uniform conversion layer thickness.

The distance between a surface of the component and a heating device, i.e., a heating column or heating element, may be less than 50 cm. This enables an even heat distribution in the treatment bath to be achieved quickly.

The treatment container may be designed with a round or square or hexagonal container circumference when viewed from above. This simplifies the even distribution of the heating elements and thus the distribution of heat in the treatment container. Circular treatment containers can minimize the amount of treatment bath when treating bearing rings. Here, too, the heating column(s) and the heating elements can be arranged easily at an even distance from the large-format component. Round treatment containers may have a diameter in the range of 3.2 m to 5 m. In an example, the height of the treatment container does not exceed 1 m in order to limit the volume to be heated and to be able to apply the necessary heating power for even heating of the treatment bath.

The at least one lid may consist of at least two lid segments that can be moved independently of each other. The at least one lid or the at least one lid segment can be mounted to be horizontally movable or rotatable around a rotation axis. It is also possible to lift the lid vertically (lifting movement), for example with a crane. In addition, the at least one lid or the lid segments can be heated. This also protects the free surface of the treatment bath from heat loss.

The treatment container, including the lid, may be designed to be thermally insulated from the environment. This reduces the heat radiation and thus the heating energy required to maintain an even heat distribution in the treatment bath.

A system according to the disclosure may include at least two treatment containers. Such a treatment container can be filled with a liquid medium in the form of a degreasing medium, a rinsing medium, a blackening medium, a phosphating medium, an oil and similar to form the treatment bath.

A method for treating a surface of the at least one large-format component with a diameter or dimensions in the range of 0.5 m to 12 m in a system according to the disclosure may include the following steps carried out in succession: providing the at least one treatment container filled with a treatment bath; heating the treatment bath by means of the at least one heating column and further the at least one heating element to a treatment temperature; introducing the at least one component into the heated treatment bath; heating the treatment bath and the at least one component to the treatment temperature and maintaining the treatment temperature for a treatment period; and removing the at least one treated component from the at least one treatment container.

By using the system according to the disclosure, large-format components can be treated evenly in the area of their surface. For example, in blackening or phosphating methods, large components can be provided with a uniform conversion layer.

Large treatment containers required for the treatment of large-format components are more difficult to maintain at a uniform temperature than smaller treatment baths. During a blackening process, the temperature of the treatment bath should be kept just below boiling temperature so that a conversion layer of iron(II,III) oxide is formed which adheres firmly to the component and is correspondingly resistant to abrasion. If the temperature of the treatment bath drops too far below the boiling temperature in places, instead of iron (II,III) oxide only red rust (Fe₂O₃) is formed, which is more voluminous, and does not adhere sufficiently to the component. This not only leads to conversion layer areas on the component of varying thickness (thickness differences in the range of about 0.5 to 2 μm occur), which differ in color, but also the abrasion resistance of the conversion layer varies locally due to the different adhesion to the metal substrate.

For the method, at least two components may be treated simultaneously in one treatment container. Several components may be treated simultaneously in several treatment containers of the system. This can increase the utilization of the system and the output of finished components.

The components to be treated may be preheated before they are placed in the first treatment container of the system. This shortens the treatment time in the first treatment container and enables a faster heat equalization with the treatment bath.

The large-format components are, for example, metallic bearing components for rolling or sliding bearings, metallic automotive components and similar. Such large-format components, mainly in the form of metallic bearing components such as bearing rings or rolling elements, especially made of steel, are required for use in wind turbines, for example. Bearing rings, for example, may be treated while lying in the treatment container.

### BRIEF DESCRIPTION OF THE DRAWINGS

FIGS. 1 to 7 are intended to illustrate systems according to the disclosure and methods by way of example. The figures illustrate the following:

FIG. 1 schematically shows a first system with a square treatment container in the top view in section I-I (cf. FIG. 2);

FIG. 2 shows the first system according to FIG. 1 in section II-II in a side view;

FIG. 3 shows a schematic diagram of the first system in the top view, equipped with three components;

FIG. 4 shows a schematic diagram of the first system in the top view, equipped with five components;

FIG. 5 schematically shows the first system in side view and sectional view, equipped with three components;

FIG. 6 schematically shows a second system with a circular treatment container in the top view in section VI-VI (cf. FIG. 7); and

FIG. 7 shows the second system according to FIG. 6 in section VII-VII in a side view.

### DETAILED DESCRIPTION

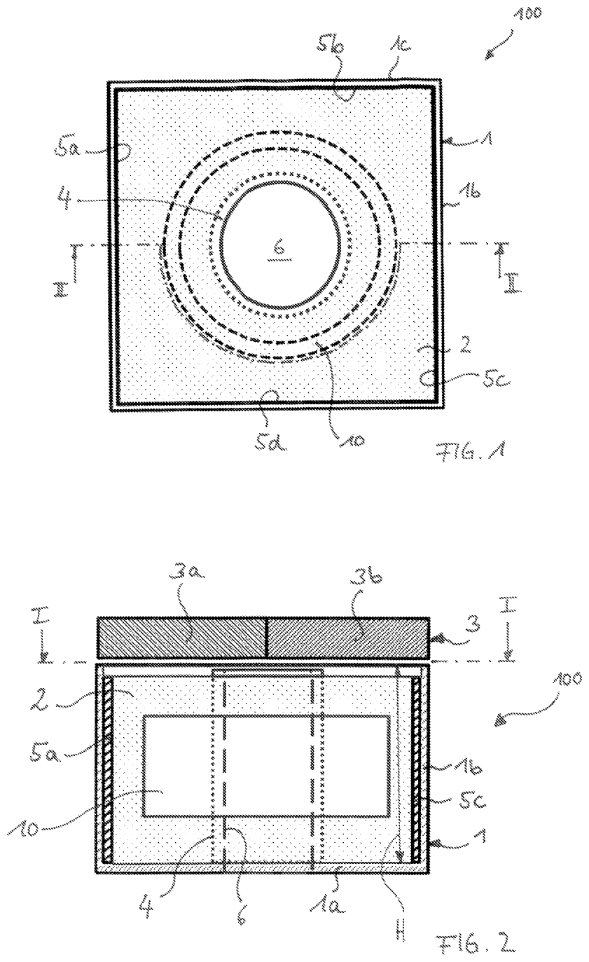

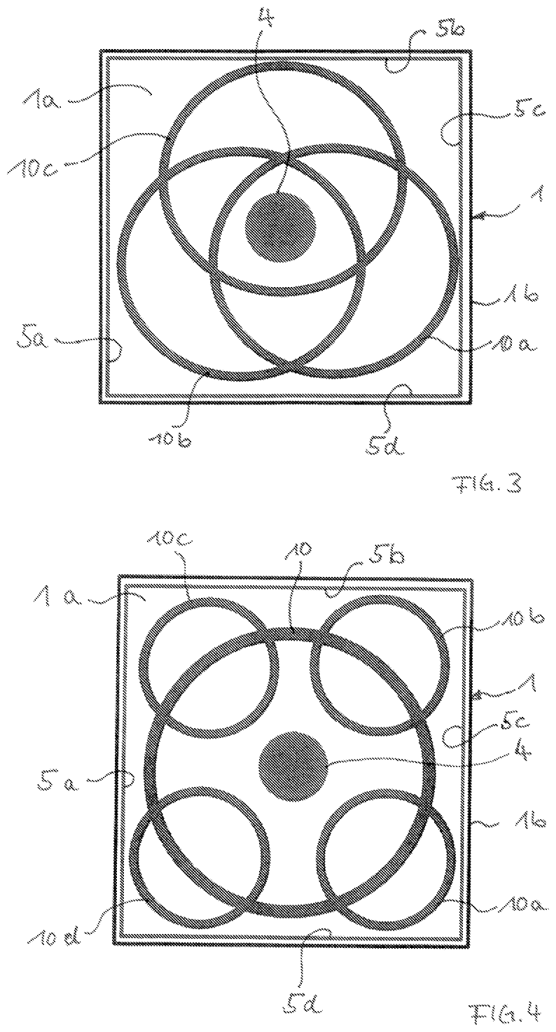

FIG. 1 shows schematically a first system 100 for the treatment of a surface of the at least one large-format component 10, in this case a bearing ring, with a diameter in the range of 0.5 m to 12 m. The first system 100 consists of a heatable treatment container 1, which is shown here in the top view in section I-I (cf. FIG. 2). The treatment container 1 has a square container circumference of 1c. The treatment container 1 is designed to hold a treatment bath 2, whereas such a treatment bath 2 is provided here for the treatment of component 10. The position of component 10 in treatment bath 2 is indicated by dashed lines. The treatment container 1 has a container bottom 1a (cf. FIG. 2) and a container wall 1b. In the area of the container wall 1b, plate-shaped heating elements 5a, 5b, 5c, 5d are arranged through which hot thermal oil flows and is heated.

An electrically heated heating column 4 is arranged in the middle of the treatment container 1, which here extends from container bottom 1a to a lid 3 (cf. FIG. 2). The heating column 4 is designed as a hollow cylinder, the interior of which is accessible via an opening 6 in the container bottom 1a. Alternatively, the heating column 4 can also be designed as a full cylinder. Alternatively, heating of heating column 4 via additional thermal oil is also possible.

FIG. 2 shows the first system 100 as shown in FIG. 1 in section II-II in a side view. The same reference characters as in FIG. 1 indicate identical elements. Here you can see that treatment container 1 has a container bottom 1a and a container wall 1b adjacent to container bottom 1a. In addition it can be seen that the treatment container 1 has a removable lid 3, which consists of two independently removable lid segments 3a, 3b. This can be done by a sliding movement, a lifting movement or a rotary movement. The heating elements 5a, 5b, 5c, 5d extend over 95% of the height H of the container wall 1b.

FIG. 3 shows schematically the first system 100 in the top view. For a better overview, treatment bath 2 is not shown here. The same reference characters as in FIGS. 1 and 2 indicate identical elements. Three components 10a, 10b, 10c are arranged in the treatment container 1 in the form of metallic bearing rings stacked on top of each other. For this purpose, components 10a, 10b, 10c are placed on a storage rack (not shown) in the illustration without direct contact with each other so that their surfaces can be rinsed evenly from treatment bath 2.

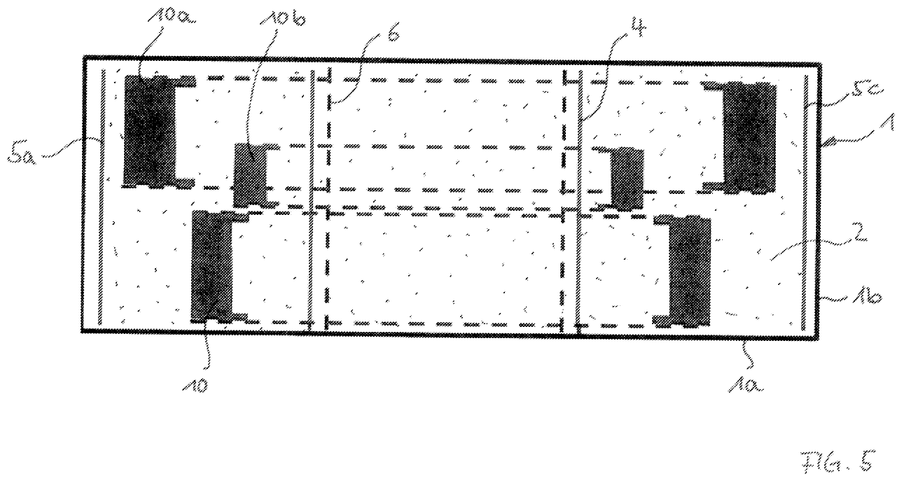

FIG. 4 shows schematically the first system 100 in the top view. For a better overview, treatment bath 2 is not shown here. The same reference characters as in FIGS. 1 and 2 indicate identical elements. Five components 10, 10a, 10b, 10c, 10d in the form of metallic bearing rings are arranged on top of each other and stacked next to each other in treatment container 1. For this purpose, components 10, 10a, 10b, 10c, 10d are placed on a storage rack not shown in the illustration, without direct contact with each other, so that their surfaces can be rinsed evenly by a treatment bath.

FIG. 5 shows schematically the first system 100 in side view and sectional view, equipped with the three components 10, 10a, 10b. The same reference characters as in FIGS. 1 and 2 indicate identical elements. The components 10, 10a, 10b are placed on a storage rack (not shown) without direct contact to each other, so that their surfaces can be rinsed evenly through the treatment bath 2.

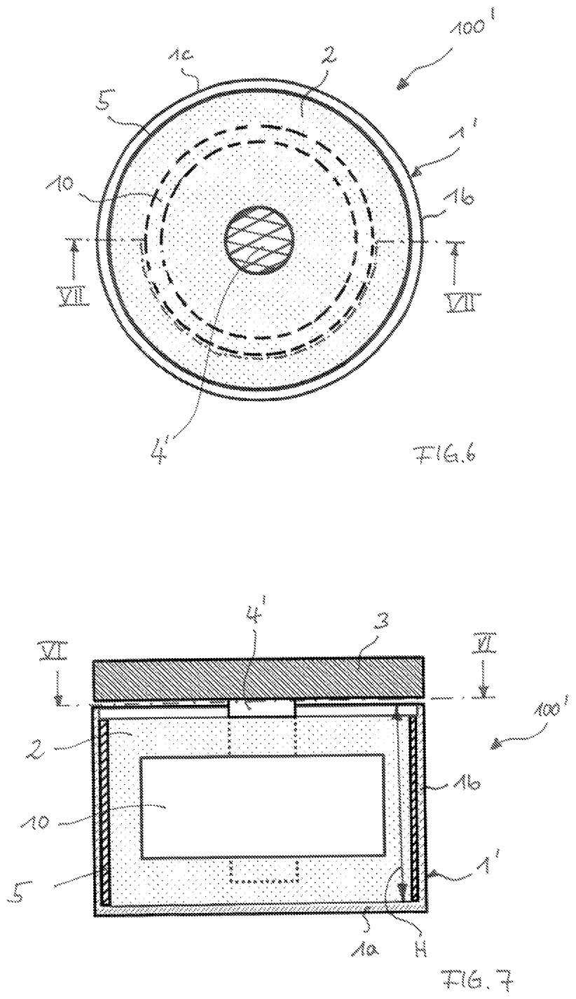

FIG. 6 shows schematically a second system 100′ for treating a surface of the large-format component 10, here a bearing ring, with a diameter in the range of 10 m. The second system 100′ includes a heatable treatment container 1′, which is shown here in the top view in section VI-VI (cf. FIG. 7). The treatment container 1′ has a circular container circumference of 1c. The treatment container 1′ is designed to hold a treatment bath 2, whereas such a treatment bath 2 is provided here for the treatment of component 10. The position of component 10 in treatment bath 2 is indicated by dashed lines. The large-format component 10 in the form of a bearing ring is placed between the heating column 4′ and a circular heating element 5 in an arrangement concentric to the heating column 4′ in treatment bath 2. As a result, the exterior diameter of the bearing ring has a uniform distance from the circular heating element 5 and the interior diameter of the bearing ring has a uniform distance from the heating column 4′. This symmetrical arrangement enables a particularly rapid and uniform formation of a uniform heat distribution in treatment bath 2 and the formation of a conversion layer of particularly uniform thickness on the surface of component 10.

The treatment container 1′ has a container bottom 1a (cf. FIG. 7) and a container wall 1b. In the area of the container wall 1b the circular heating element 5 is arranged, through which hot thermal oil flows and is heated. An electrically heated heating column 4′ is arranged in the middle of the treatment container 1′, which here extends from lid 3 (cf. FIG. 7) towards the container bottom 1a. Here the heating column 4′ is designed as a full cylinder and attached to the lid 3. Alternatively, a version according to FIG. 1 is possible, in which the heating column is arranged starting from container bottom 1a, or a combination of a heating column on the lid and another heating column on the container bottom.

FIG. 7 shows the second system 100′, as shown in FIG. 6 in section VII-VII in a side view. The same reference characters as in FIG. 6 indicate identical elements. Here you can see that the treatment container 1′ has a container bottom 1a and a container wall 1b adjacent to the container bottom 1a. You can also see that the treatment container 1′ has the removable lid 3. This removal of the lid 3 is done here by a lifting movement. The annular heating element 5 extends from the container bottom 1a over more than 95% of the height H of the container wall 1b.

FIGS. 1 to 7 show only examples of the design of systems according to the disclosure. A system can thus continue to include a first heating column from container bottom 1a and a second heating column from lid 3, such that the first and second heating columns are dimensioned in their length so that they do not touch each other. In addition, a lid 3 or the lid segments 3a, 3b can be heated. Electrical heating or heating by passing a hot thermal oil through can also be used here.

On the basis of FIGS. 6 and 7, the following is an example of a method according to the invention for treating a surface of the large-format metallic component 10 (bearing ring) with a diameter of 10 m. Five treatment containers 1′ as shown in FIG. 6 are provided side by side, a first treatment container being filled with a degreasing medium, a second treatment container with a rinsing medium, a third treatment container with a blackening bath, a fourth treatment container with a further rinsing medium and the fifth treatment container with an oil. The respective treatment medium or treatment bath 2 is heated to a treatment temperature with the help of the heating column 4′ and the heating element 5.

The component 10, possibly preheated, is introduced successively into the heated treatment baths 2, where it is degreased in the first treatment container, then rinsed in the second treatment container, blackened in the third treatment container, rinsed again in the fourth treatment container and oiled in the fifth treatment container. While component 10 is in the respective treatment container 1′, treatment bath 2 and component 10 are heated to the respective required treatment temperature. This treatment temperature is kept constant over a treatment period. The removal of the treated component 10 from the respective treatment container 1′ and a transfer to the next treatment container 1′ is carried out with the help of a crane. Depending on the desired treatment process, there may be more or fewer treatment containers available.

### REFERENCE NUMERALS

1, 1′ Treatment container
1a Container bottom
1b Container wall
1c Circumference of the container
2 Treatment bath
3 Lid
3a, 3b Lid segment
4, 4′ Heating column
5, 5a, 5b, 5c, 5d Heating element
6 Opening
10, 10a, 10b, 10c, 10d Component
100, 100′ System
H Height of the container wall 1b

1.-10. (canceled)

11. A heatable treatment container for receiving a treatment bath for treating a surface of at least one large-format component having a diameter or dimensions in the range of 0.5 m to 12 m, comprising:
a container base with a container bottom;
a container wall adjoining the container base;
a removable lid; and
a central heating column:
extending from the container bottom towards the removable lid; or
extending from the removable lid towards the container bottom.

12. The heatable treatment container of claim 11 wherein the central heating column extends from the container bottom over at least 50% of a height of the container wall towards the removable lid.

13. The heatable treatment container of claim 11 wherein the central heating column extends from the removable lid over at least 50% of a height of the container wall towards the container bottom.

14. The heatable treatment container of claim 11 wherein the central heating column:
has a cylindrical outer surface; and
is arranged to emit heat radially to the treatment bath.

15. The heatable treatment container of claim 11, further comprising a heating element disposed near the container wall and arranged to emit heat to the treatment bath towards the central heating column.

16. The heatable treatment container of claim 15, wherein the heating element is an annular heating element.

17. The heatable treatment container of claim 15, wherein the heating element comprises at least four rod or plate shaped heating elements arranged at equal distances from each other on the container wall surrounding the central heating column.

18. The heatable treatment container of claim 11, further comprising a periphery selected from the group consisting of a circle, a square, or a hexagon, when viewed in a top view.

19. The heatable treatment container of claim 11 wherein the removable lid comprises at least two lid segments which are movable independently of one another.

20. A method for treating a surface a large-format component having a diameter or dimensions in the range of 0.5 m to 12 m, comprising the following steps carried out in succession:
providing the heatable treatment container of claim 15 filled with a treatment bath;
heating the treatment bath using the central heating column and the heating element to a treatment temperature;
introducing large-format component into the treatment bath;
heating the treatment bath and the large-format component to the treatment temperature and maintaining the treatment temperature for a treatment period; and
removing the large-format component from the heatable treatment container.
